(19) United States
(12) Patent Application Publication
(10) Pub. No.: US 2007/0143008 A1
(43) Pub. Date: Jun. 21, 2007

(54) Method and apparatus for autoperforming multimodal interaction

(76) Inventors: Yeon Jun Choi, Daejeon-city (KR); Min Jung Kim, Daejeon-city (KR); Young Bag Moon, Daejeon-city (KR); Sun-Joong Kim, Daejeon-city (KR); Oh-Cheon Kwon, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/607,742

(22) Filed: Dec. 1, 2006

(30) Foreign Application Priority Data
Dec. 7, 2005 (KR) 10-2005-0118777

(51) Int. Cl. G01C 21/00

(52) U.S. Cl. 701/207

(57) ABSTRACT

An apparatus for automatically performing a multimodal interaction between a telematics terminal and a server is provided. The apparatus includes a sequence storage unit sequentially storing a user interactive response requested at each of a plurality of stages in an application provided by the server in correspondence with each of the stages, and an interaction automation unit performing a multimodal interaction when connection to the server is resumed after disconnection by automatically inputting interactive responses requested up to a last stage in the application performed before the disconnection based on the user interactive responses stored in the sequence storage unit.

### CROSS-REFERENCE TO RELATED PATENT APPLICATIONS

This application claims the benefit of Korean Patent Application No. 10-2005-0118777, filed on Dec. 7, 2005, in the Korean Intellectual Property Office, the disclosure of which is incorporated herein in its entirety by reference.

### BACKGROUND OF THE INVENTION

1. Field of the Invention

The present invention relates to a method and apparatus for automatically performing a multimodal interaction in a telematics terminal installed in a vehicle, and more particularly, to a method and apparatus for automatically performing a multimodal interaction when connection to a server is resumed after disconnection by storing and automating routine operation for the interaction with the server to perform an action on behalf of a user.

2. Description of the Related Art

With the rapid spread of a World Wide Web (WWW) based on standard language, i.e., HyperText Markup Language (HTML) expressing information on a screen and a standard protocol, i.e., HyperText Transfer Protocol (HTTP) for transferring the information, a huge amount of information on Internet can be easily accessed through a web browser. However, since a web browser requires a system including a large screen like a personal computer (PC) screen, a keyboard, and a mouse, it is not easy to access information on the Internet in a terminal such as a mobile phone or a personal digital assistant (PDA) having a small screen and a limited keyboard.

To overcome this problem, multimodal interface for simultaneously providing multiple modes of interfacing has been researched and developed to compensate for drawbacks of interface in a client using only a voice modality or a visual modality in a client-server system. In addition, the development of personalization using Java language in a general system has been performed by Sun and an approach for reflecting an individual's preference has been performed by ERTICO. However, the research and development for data mining of a user's setting pattern and preference analysis using the data mining has not been performed.

### SUMMARY OF THE INVENTION

The present invention provides a method and apparatus for autoperforming interaction with a server when remote connection to the server performed by a user in a vehicle using multimodal interface is resumed after disconnection.

According to an aspect of the present invention, there is provided an apparatus for automatically performing a multimodal interaction between a telematics terminal and a server. The apparatus includes a sequence storage unit sequentially storing a user interactive response requested at each of a plurality of stages in an application provided by the server in correspondence with each of the stages, and an interaction automation unit performing a multimodal interaction when connection to the server is resumed after disconnection by automatically inputting interactive responses requested up to a last stage in the application performed before the disconnection based on the user interactive responses stored in the sequence storage unit.

According to another aspect of the present invention, there is provided an apparatus for automatically performing a multimodal interaction between a telematics terminal and a server. The apparatus includes a personalization database unit storing user identification information used for at least one service provided by the server, a sequence storage unit sequentially storing a user interactive response requested at each of a plurality of stages in an application provided by the server so that the user interactive responses correspond to the stages, and an interaction automation unit performing a multimodal interaction when connection to the server is resumed after disconnection using the user identification information stored in the personalization database unit and the user interactive responses stored in the sequence storage unit.

According to still another aspect of the present invention, there is provided a method of automatically performing a multimodal interaction between a telematics terminal and a server. The method includes receiving a user interactive response requested at each of stages in an application provided by the server, sequentially storing the user interactive response corresponding to each of the stages of the application, and performing a multimodal interaction when connection to the server is resumed after disconnection by automatically inputting interactive responses requested up to a last stage in the application performed before the disconnection based on stored user interactive responses.

According to yet another aspect of the present invention, there is provided a method of automatically performing a multimodal interaction between a telematics terminal and a server. The method includes storing user identification information used for at least one service provided by the server, receiving a user interactive response requested at each of a plurality of stages in an application provided by the server, sequentially storing the user interactive response corresponding to each of the stages of the application, and performing a multimodal interaction when connection to the server is resumed after disconnection using the stored user identification information and the stored user interactive responses.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic block diagram of an apparatus for automatically performing a multimodal interaction according to an embodiment of the present invention;

FIG. 2 is a schematic block diagram of an apparatus for automatically performing a multimodal interaction according to another embodiment of the present invention;

FIG. 3 is a detailed block diagram of an apparatus for automatically performing a multimodal interaction according to still another embodiment of the present invention;

FIG. 4 is a detailed block diagram of a personalization block according to an embodiment of the present invention;

FIG. 5 illustrates a communication system between a server and an apparatus for automatically performing a multimodal interaction according to an embodiment of the present invention;

FIG. 6 is a flowchart of a procedure for collecting user personal information in an apparatus for automatically performing a multimodal interaction, according to an embodiment of the present invention;

FIG. 7 is a flowchart of operations performed by the apparatus for automatically performing a multimodal interaction, which accesses a server illustrated in FIG. 5; and

FIG. 8 is a flowchart of a method of automatically performing a multimodal interaction according to an embodiment of the present invention.

### DETAILED DESCRIPTION OF THE INVENTION

Hereinafter, preferred embodiments of the present invention will be described in detail with reference to the attached drawings. In the drawings, the same reference numerals denote the same member. When it seems obscure the subject of the present invention to describe related conventional functions or structures in detail, detailed descriptions thereof will be omitted.

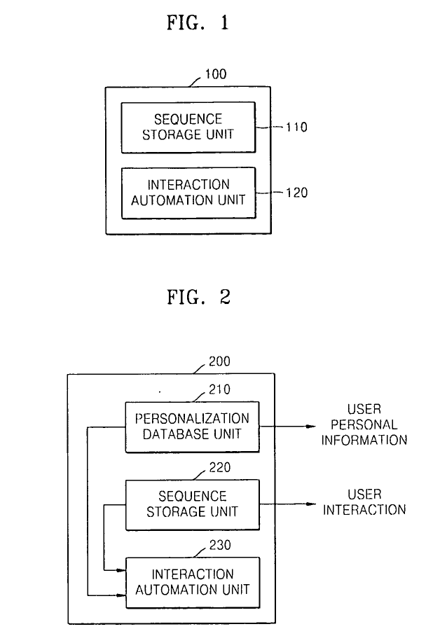

FIG. 1 is a schematic block diagram of an apparatus 100 for automatically performing a multimodal interaction according to an embodiment of the present invention. The apparatus 100 includes a sequence storage unit 110 and an interaction automation unit 120.

In communication between a telematics terminal and a telematics server, the server provides a user with applications (e.g., CGI, HTML, ASP, JSP, and ActiveX control) needed for response. The sequence storage unit 110 sequentially stores a user's interactive response requested at each of the stages in an application service provided by the telematics server for the user of the telematics terminal in correspondence to each stage in the application service. In other words, the sequence storage unit 110 sequentially stores a user's interactive responses requested at respective stages in an application service provided by a server so that a state of service provided by the server can be recognized even when connection to the server is disconnected.

When connection to a server providing an application service is resumed after disconnection, the interaction automation unit 120 progresses the application service up to the stage, to which the application service had been performed before the disconnection, using the user's interaction responses stored in the sequence storage unit 110. As a result, even when the connection to the server is resumed after disconnection, the application service can be automatically resumed from the beginning and continued without newly requesting interaction responses from the user.

FIG. 2 is a schematic block diagram of an apparatus 200 for automatically performing a multimodal interaction according to another embodiment of the present invention. The apparatus 200 includes a personalization database unit 210, a sequence storage unit 220, and an interaction automation unit 230.

A telematics terminal installed in a vehicle may be connected to various electronic control devices (e.g., a wiper and an autometer), a global positioning system (GPS), various user input/output devices (e.g., a display, a keyboard, a mouse, and an audio device), communication devices (e.g., a mobile communication device, Bluetooth, a wireless local area network (WLAN), and Wibro), various broadcasting systems (e.g., a radio broadcasting system and a digital multimedia broadcasting (DMB) system), etc., and is thus connected to a user in the vehicle, the vehicle, and services outside the vehicle.

The personalization database unit 210 analyzes telematics services, devices installed in a vehicle, and other software that a user riding the vehicle equipped with telematics usually uses and stores the user's regular actions or repeated user information. For example, the personalization database unit 210 stores the user's social security number, credit card information, and other personal information which are input by the user using telematics services. In addition, the personalization database unit 210 analyzes the user's preference regarding with devices such as a radio and a temperature controller installed in the vehicle, use frequencies of the devices, etc. stores the analysis result, and minimizes interaction between the user and a telematics server based on the analysis result.

When a service like a web application is provided from a telematics server, the sequence storage unit 220 stores a user interactive response requested at each of the stages in the service. In other words, the sequence storage unit 220 stores the history of user interactive responses respectively corresponding to stages in a web application service.

The interaction automation unit 230 minimizes interaction between a user riding in a vehicle equipped with telematics and a telematics server based on information stored in the personalization database unit 210. In addition, when connection to the server is resumed after disconnection, the interaction automation unit 230 generates an interaction sequence for performing service stages that has been performed before the disconnection using predefined Extensible Markup Language (XML) based on the user interactive responses stored in the sequence storage unit 220 and progresses a service on behalf of the user. Here, the user's interaction may be converted into language such as XML supporting multimodality so that the apparatus 200 can operate regardless input/output modalities such as a visual modality and a voice modality.

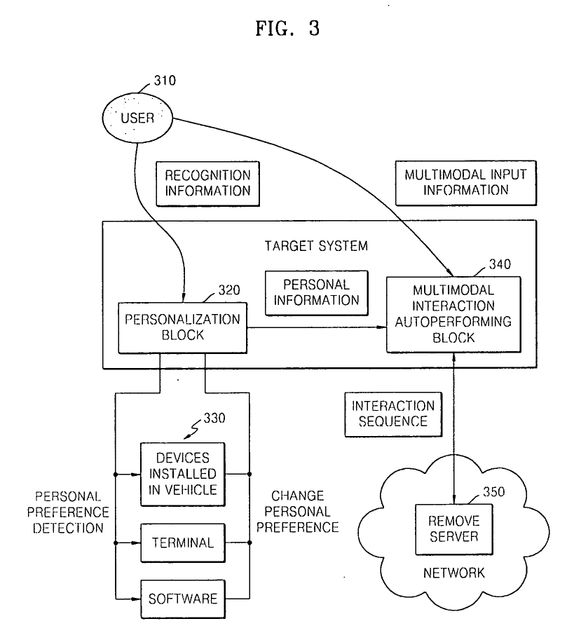

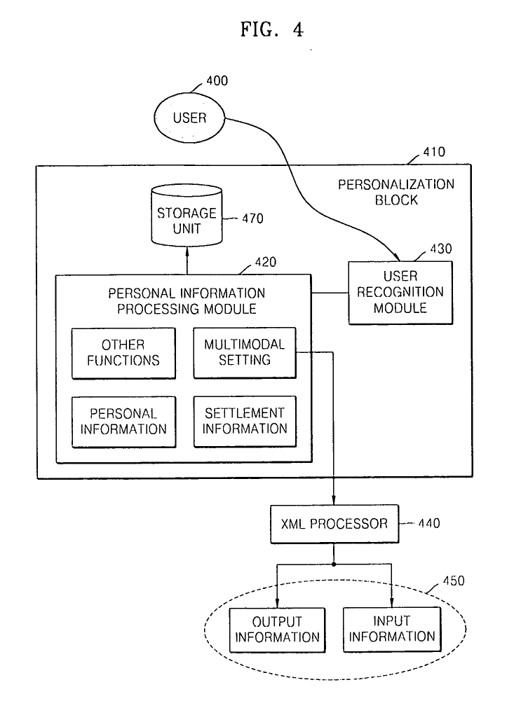

FIG. 3 is a detailed block diagram of an apparatus for automatically performing a multimodal interaction according to still another embodiment of the present invention. A personalization database block 320 performs user authentication using a conventional recognition method (using an ID and a password, an iris, a fingerprint, a mobile phone, a front face, or the like) to determine whether a user 310 is authorized to use the apparatus for automatically performing a multimodal interaction. The personalization database block 320 analyzes telematics services, devices installed in a vehicle, and other software, which are usually used by the user 310 riding the vehicle equipped with telematics; stores the user's regular actions or repeated user information; and sets the user's personal preference based on the stored information. In addition, the personalization database block 320 stores user personal information input by the user 310 to use telematics services, devices installed the vehicle, and software 330.

In detail, after the user 310 is authenticated in a telematics terminal installed in the vehicle, the personalization database block 320 collects actions (e.g., tuning to radio channels, adjusting of internal temperature using a temperature controller, and inputting of an ID and a password to use a particular web service) made by the user 310 in the telematics terminal, stores regular part and repeated part of the collected actions, and detects personal preference based on the stored regular and repeated parts of the actions.

The apparatus for automatically performing a multimodal interaction implemented in, for example, a telematics terminal can reset the devices and the software 330 installed in the vehicle based on the personal preference detected by the personalization database block 320, thereby minimizing interaction between the user 310 and a remote telematics server 350.

A multimodal interaction autoperforming block 340 uses personal information stored in the personalization database block 320 or personal preference detected by the personalization database block 320. The multimodal interaction autoperforming block 340 sequentially stores user interactions respectively requested at stages in a service provided by the telematics server 350 during communication with the telematics server 350. Here, the user interactions are multimodal interactive responses including voice responses, visual responses, and tactile responses.

When a network connection or a session is resumed after disconnection, a client agent, i.e., the multimodal interaction autoperforming block 340 transmits interactive responses stored till the disconnection to the telematics server 350. Service stages in an application performed till the disconnection are performed in the telematics server 350. Thereafter, the application is continued in the telematics terminal.

FIG. 4 is a detailed block diagram of a personalization block 410 according to an embodiment of the present invention. The personalization block 410 is a preferred embodiment of the personalization database block 210 illustrated in FIG. 2 and collects personal information and settlement information during telematics services. A personal information processing module 420 converts a voice response, a tactile response, a response made using a keyboard, etc. into output information of an output device or input information of an input device using predefined XML.

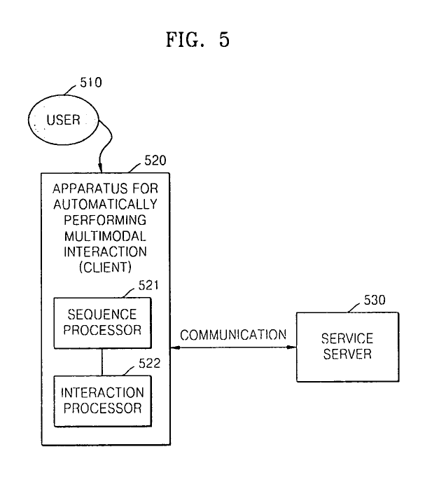

FIG. 5 illustrates a communication system between a service server 530 and an apparatus 520 for automatically performing a multimodal interaction according to an embodiment of the present invention. The apparatus 520 includes a sequence processor 521 storing, analyzing, and executing each of the sequences of an application service provided by the service server 530; and an interaction processor 522 interpreting, generating, and executing a user interactive response corresponding to each sequence of the application service.

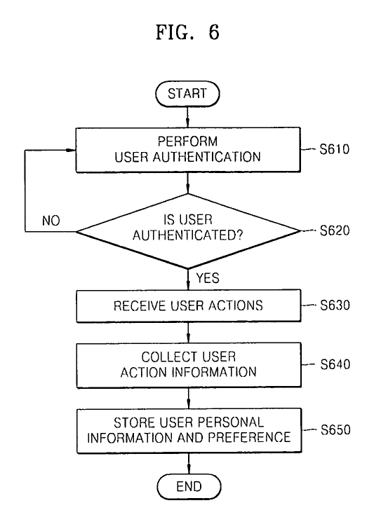

FIG. 6 is a flowchart of a procedure for collecting user personal information in an apparatus for automatically performing a multimodal interaction, according to an embodiment of the present invention. In operation S610, user authentication is performed to determine whether a user riding a vehicle is an authentic user registered in a terminal. When the user is authenticated in operation S620, user action information is collected based on actions performed by the user in the vehicle and user personal information and preference are analyzed and stored in operations S630, S640, and S650.

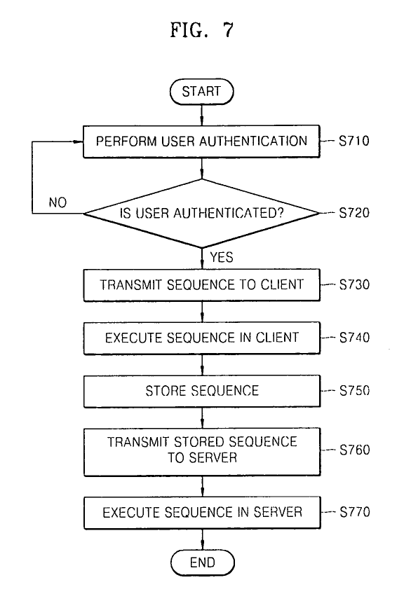

FIG. 7 is a flowchart of operations performed by the apparatus 520 for automatically performing a multimodal interaction, which accesses the server 530 illustrated in FIG. 5. After a user riding a vehicle is authenticated in operations S710 and S720, the server 530 transmits a sequence indicating each of the service stages in an application to the apparatus 520 in operation S730. Thereafter, a telematics terminal included in a client, i.e., the apparatus 520 executes the sequence transmitted from the server 530 in operation S740 and stores the sequence and a user interactive response corresponding to the sequence together in operation S750. Thereafter, the apparatus 520 transmits the sequence and the corresponding user interactive response to the server 530 in operation S760. The server 530 executes the sequence in operation S770, thereby providing the application service to the user.

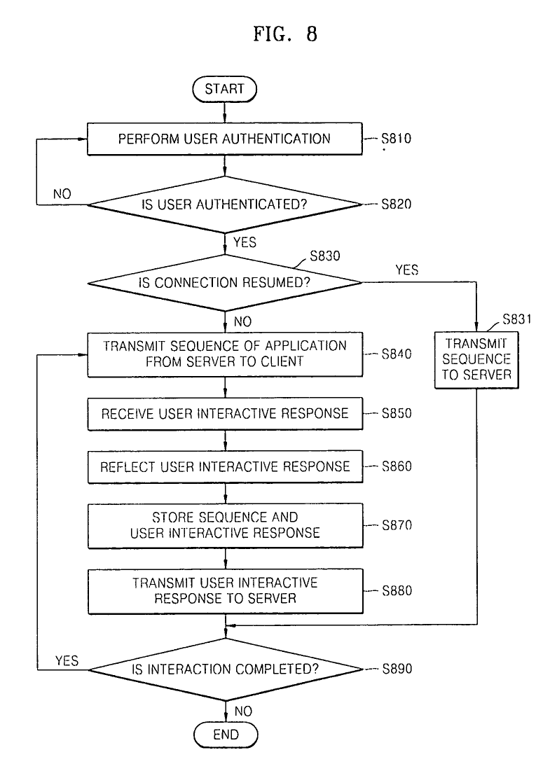

FIG. 8 is a flowchart of a method of automatically performing a multimodal interaction according to an embodiment of the present invention. Usually, in communication between a telematics terminal and a server, user identification information used for at least one service provided by the server is stored. The server receives a user's interactive response requested at each of the stages in an application service from a client. The client transmits user interactive responses requested at respective sequences respectively indicating stages in an application service provided by the server and sequentially stores the user interactive responses.

When connection to the server is resumed after disconnection, the user is authenticated through a minimum interaction with the server using the stored user identification information and user preference information in operations S810 and S820. Thereafter, in operations S850 through S890, the user identification information and the user interactive responses stored in the client or the telematics terminal are transmitted to the server so that service executed till before the disconnection is automatically performed. In other words, the client progresses communication with the server based on the stored user interactive responses without requesting the user to input interactive responses.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

According to the present invention, when connection to a telematics server is resumed after disconnection in a telematics terminal installed in a vehicle, a service performed till the disconnection is autoperformed on behalf of a user based on interaction responses received from the user before the disconnection regardless of an input/output modality such as a visual or voice modality. Accordingly, simpler interaction is needed, and therefore, the user is less distracted while driving the vehicle.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for automatically performing a multimodal interaction between a telematics terminal and a server, the apparatus comprising:
a sequence storage unit sequentially storing a user interactive response requested at each of a plurality of stages in an application provided by the server in correspondence with each of the stages; and
an interaction automation unit performing a multimodal interaction when connection to the server is resumed after disconnection by automatically inputting interactive responses requested up to a last stage in the application performed before the disconnection based on the user interactive responses stored in the sequence storage unit.

2. An apparatus for automatically performing a multimodal interaction between a telematics terminal and a server, the apparatus comprising:
a personalization database unit storing user identification information used for at least one service provided by the server;
a sequence storage unit sequentially storing a user interactive response requested at each of a plurality of stages in an application provided by the server so that the user interface responses correspond to the stages of the application; and
an interaction automation unit performing multimodal interaction when connection to the server is resumed after disconnection using the user identification information stored in the personalization database unit and the user interactive responses stored in the sequence storage unit.

3. The apparatus of claim 1 or 2, wherein the user interactive responses are multimodal interactive responses comprising a voice response, a visual response, and a tactile response.

4. A method of automatically performing multimodal interaction between a telematics terminal and a server, the method comprising:
receiving a user interactive response requested at each of a plurality of stages in an application provided by the server;
sequentially storing the user interactive response corresponding to each of the stages of the application; and
performing multimodal interaction when connection to the server is resumed after disconnection by automatically inputting interactive responses requested up to a last stage in the application performed before the disconnection based on the stored user interactive responses.

5. A method of automatically performing a multimodal interaction between a telematics terminal and a server, the method comprising:
storing user identification information used for at least one service provided by the server;
receiving a user interactive response requested at each of a plurality of stages in an application provided by the server;
sequentially storing the user interactive response corresponding to each of the stages in the application; and
performing a multimodal interaction using the stored user identification information and the stored user interactive responses when connection to the server is resumed after disconnection.

6. The method of claim 4 or 5, wherein the user interactive responses are multimodal interactive responses comprising a voice response, a visual response, and a tactile response.
